(19) United States
(12) Patent Application Publication
(10) Pub. No.: US 2006/0233550 A1
(43) Pub. Date: Oct. 19, 2006

(54) Wavelength division multiplexed light source and passive optical network using the same

(75) Inventors: Dong-Jae Shin, Suwon-si (KR); Seong-Taek Hwang, Pyeongtaek-si (KR); Dae-Kwang Jung, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/406,135

(22) Filed: Apr. 18, 2006

(30) Foreign Application Priority Data
Apr. 18, 2005 (KR) 2005-31949

(51) Int. Cl. H04J 14/02

(52) U.S. Cl. 398/79

(57) ABSTRACT

A wavelength division multiplexed light source for a passive optical network using the same includes broadband light sources arranged at a desired interval on a wavelength axis, so as to output wavelength bands each having a plurality of structural wavelengths. Further included is a main coarse wavelength division multiplexer (M-CWDM) for multiplexing the lights and a dense wavelength division multiplexer (DWDM) for spectrally dividing the multiplexed light into the channels corresponding to structural wavelengths of the multiplexed light. Groups are consequently generated each of which has a plurality of channels spaced at wavelength period.

### CLAIM OF PRIORITY

This application claims priority to an application entitled “Wavelength Division Multiplexed Light Source and Passive Optical Network Using the Same,” filed with the Korean Intellectual Property Office on Apr. 18, 2005 and assigned Serial No. 2005-0031949, the contents of which are incorporated herein by reference.

### BACKGROUND OF THE INVENTION

1. Field of the Invention

The present invention relates to a passive optical network, and more particularly to a wavelength division multiplexed light source and a passive optical network using the same.

2. Description of the Related Art

An optical network of current interest includes a central office to which subscriber devices are connected by optical fibers so as to provide various broadband services. Point to point connections of the central office and each subscriber device would require too many optical fibers. Therefore, it is general practice to install remote nodes near the subscriber devices, to connect the central office to the remote nodes by a small number of trunk optical fibers, and to connect the remote node to the subscriber devices point to point by using distributed optical fibers. The remote node plays the role of demultiplexing downstream optical signals inputted from the central office, and multiplexing upstream optical signals inputted from the subscriber devices.

Such optical networks may be classified into active or passive, depending on the necessity of the power supply to structural elements in the remote node. The passive optical network is currently the focus of attention. The cost required for maintaining, repairing, and managing the remote node is relatively less expensive than that of an active optical network.

In a wavelength division multiplexed passive optical network, different wavelengths are assigned to respective subscribers. Optical signals generated from respective light sources are multiplexed by a wavelength division multiplexer. It is very important that the wavelength arrangement realized between the light sources and the wavelength division multiplexer be economical in the sense of reducing the cost of maintaining and repairing the network. Proposed implementations of the wavelength division multiplexed light source include: a distributed feedback laser array, a high performance light emitting diode array, and a spectrum-sliced light source. Recently, an external light injection type injection light source has been proposed in which an outputted wavelength does not depend on the light source and is determined by the light injected from the exterior, in order to easily maintain and repair the light source. This external light injection type injection light source may be implemented, for example, as a light injection type Fabry-Perot laser diode or as a light injection type reflective semiconductor optical amplifier. An advantage of the external light injection type light source is that one kind of light source can output optical signals of different wavelengths without particular control of the light source. Instead, for this single kind of light source, the wavelength of the light source is determined by the injected light. Since it is unnecessary to fix wavelength assignments between the light sources and the wavelength division multiplexer, the operation, maintenance and repair of the network are simplified. Moreover, in order to economically realize the wavelength division multiplexed passive optical network, it is very important to supply an inexpensive wavelength division multiplexer. The arranged waveguide grating, which is a representative material used for the wavelength division multiplexer, is still expensive. The more dense the arranged waveguide grating is, higher in its price. Therefore, when the wavelength division multiplexer included in the wavelength division multiplexed light source is made to be highly dense in order to increase the maximum number of subscribers, the cost of realizing the dense wavelength division multiplexer increases and the cost of realizing the optical network using the dense wavelength division multiplexer also increases.

As described above, it is costly to manufacture the conventional wavelength division multiplexed light source and the optical network using the same.

A need therefore exists for a new wavelength division multiplexed light source and an optical network that can be economically realized and that can accommodate a great number of subscribers.

### SUMMARY OF THE INVENTION

The present invention has been made to solve the above-mentioned problems occurring in the prior art. In one aspect, the present invention is directed to providing a wavelength division multiplexed light and a passive optical network using the same that can be realized economically and can accommodate a great number of subscribers.

According to the first aspect of the present invention, there is provided a wavelength division multiplexed light source which comprises: a plurality of broadband light sources producing respective light bands, the light bands having respective pluralities of structural wavelengths, the structural wavelengths having corresponding channels, the plural sources being arranged such that a wavelength period between a start of a current band and a start of a next band is uniform along a wavelength axis; a main coarse wavelength division multiplexer (M-CWDM) which multiplexes a plurality of lights inputted from the broadband light sources so as to output a multiplexed light; and a dense wavelength division multiplexer (DWDM) which spectrally divides the multiplexed light inputted from the M-CWDM into said channels, so as to generate multiple different groups whose channels are spaced apart by said wavelength period.

According to the second aspect of the present invention, there is provided a wavelength division multiplexed light source which comprises: a dense wavelength division multiplexer (DWDM) which spectrally divides lights having different wavelength bands, said bands being periodically disposed on a wavelength axis such that a wavelength period between a start of a current band and a start of a next band is uniform along said axis, said current band having a plurality of structural wavelengths, the spectral division being into channels corresponding to the structural wavelengths of the lights so as to generate multiple different groups whose ones of said channels are spaced apart by said wavelength period; a plurality of secondary coarse wavelength division multiplexers (S-CWDMs) which are connected to the DWDM and demultiplex said channels; and external light injection type light sources connected to corresponding ones of the plural S-CWDMs, so as to output optical signals in which data are modulated, said signals being generated by corresponding ones of said channels.

According to the third aspect of the present invention, there is provided a passive optical network which comprises: a central office outputting multiplexed optical signals, which includes: a dense wavelength division multiplexer (DWDM) which spectrally divides lights having different wavelength bands, said bands being periodically disposed on a wavelength axis such that a wavelength period between a start of a current band and a start of a next band is uniform along said axis, said current band having a plurality of structural wavelengths, the spectral division being into channels corresponding to the structural wavelengths of the lights so as to generate multiple different groups whose ones of said channels are spaced apart by said wavelength period; a plurality of secondary coarse wavelength division multiplexers (S-CWDMs) which are connected to the DWDM and demultiplex said channels; and external light injection type light sources connected to corresponding ones of the plural S-CWDMs, so as to output optical signals in which data are modulated, said signals being generated by corresponding ones of said channels;

According to the fourth aspect of the present invention, there is provided a passive optical network which comprises: a passive optical network comprising: a central office outputting multiplexed optical signals; a remote node demultiplexing the multiplexed optical signals inputted from the central office through a trunk optical fiber, which includes: a dense wavelength division multiplexer (DWDM) demultiplexing the multiplexed optical signals inputted from the central office into their structural optical signals, so as to output optical signals of a plurality of different groups whose respective ones of the outputted optical signals are spaced at the free spectral range; and a plurality of secondary coarse wavelength division multiplexers (S-CWDMs) that are connected to the DWDM and demultiplex the optical signals of the corresponding group inputted from the DWDM so as to output demultiplexed optical signals; and a subscriber side apparatus detecting, by electric signals, demultiplexed optical signals inputted from the remote node through distributed optical fibers of the plural groups.

According to the fifth aspect of the present invention, there is provided a passive optical network which comprises: a passive optical network comprising: a central office multiplexing lights of different wavelength bands which are periodically arranged on a wavelength axis and respectively have a plurality of structural wavelengths, so as to output the multiplexed lights; a remote node spectrally dividing the multiplexed lights, which are inputted from the central office through a trunk optical fiber, into channels corresponding to structural wavelengths of the light, so as to output the channels of multiple different groups having corresponding pluralities of channels spaced at a wavelength period common between consecutive pairs of the channels; and a subscriber side apparatus including external light injection type light sources of respective ones of the groups, said sources outputting optical signals of the corresponding group, data being modulated in said optical signals, said signals being generated by channels of the corresponding group injected from the remote node.

### BRIEF DESCRIPTION OF THE DRAWINGS

The above features, and advantages of the present invention will be more apparent from the following detailed description taken in conjunction with the accompanying drawings, in which:

FIG. 1 is a block diagram showing a wavelength division multiplexed light source according to the preferred embodiment of the present invention;

FIG. 2 is a spectral diagram showing the first, second, third, . . . , and M band light which are emitted from the first, second, third, . . . , and M band light sources, respectively, shown in FIG. 1;

FIG. 3 is a spectral diagram illustrating a spectrum division characteristic of a dense wavelength division multiplexer shown in FIG. 1;

FIG. 4 is a conceptual diagram illustrating an input/output characteristic of an external light injection type Fabry-Perot laser diode;

FIG. 5 is a conceptual diagram illustrating an input/output characteristic of an external light injection type reflective semiconductor optical amplifier;

FIG. 6 is a spectral diagram showing the first, second, third, . . . , and N^{th} groups of optical signals which propagate into the wavelength division multiplexed light source shown in FIG. 1;

FIG. 7 is a block diagram showing a passive optical network using a wavelength division multiplexed scheme according to the first embodiment of the present invention;

FIG. 8 is a block diagram showing a passive optical network using a wavelength division multiplexed scheme according to the second embodiment of the present invention; and

FIG. 9 is a spectral diagram showing the first, second, third, and M^{th} downstream bands and the first′, second′, third′, . . . , (M′)^{th} upstream bands.

### DETAILED DESCRIPTION

In the following discussion, detailed description of known functions and configurations incorporated herein is omitted for clarity of presentation.

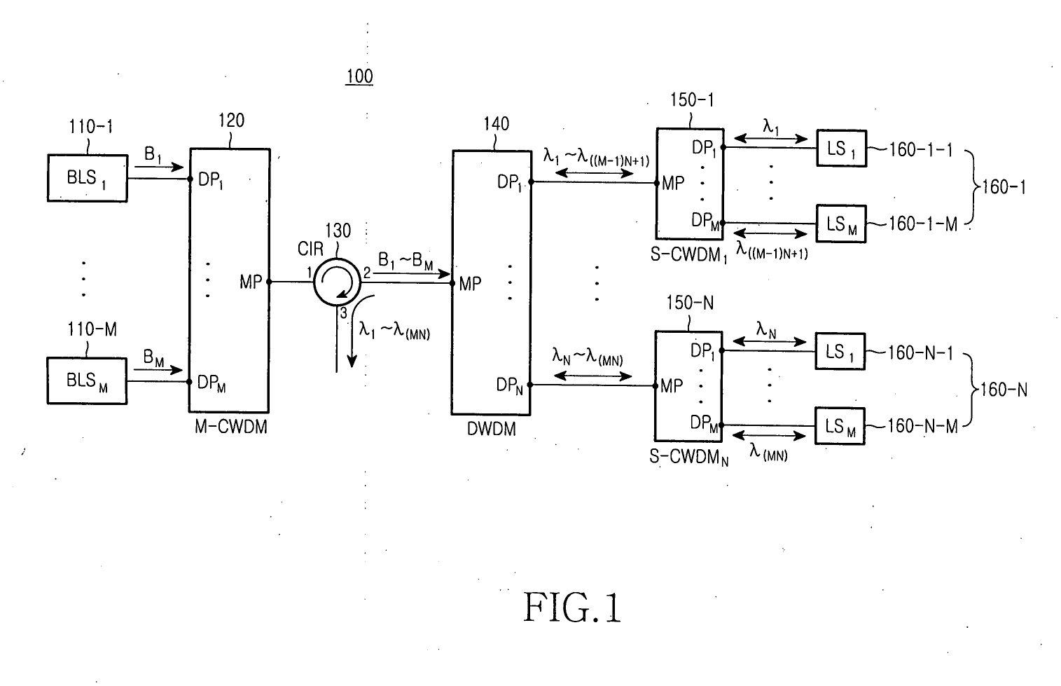

FIG. 1 depicts, by illustrative and non-limitative example, a wavelength division multiplexed light source 100 according to the present invention. It includes first, second, third, . . . , and M^{th} broadband optical sources 100-1, 100-2, 100-3, . . . , 100-M; a main coarse wavelength division multiplexer (M-CWDM) 120; an optical circulator (CIR) 130; a dense wavelength division multiplexer (WDM) 140; first, second, third, . . . , N^{th} secondary coarse wavelength division multiplexers (S-CWDM) 150-1, 150-2, 150-3, . . . , 150-N; and first, second, third, . . . , N^{th} groups of external light injection type light sources (LS) 160-1-1, 160-1-2, 160-1-3, . . . , 160-N-M. The density of a wavelength division multiplexer refers to the periodical interval between wavelengths of input to be multiplexed or wavelengths of demultiplexed output, high density meaning that the interval is narrower than in the case of lower density. Hereinafter, light of a band is assumed not to be modulated throughout the band. A channel denotes light having predetermined wavelength in which data cannot be modulated. The expression “optical signals” refers to light of a predetermined wavelength in which data are modulated.

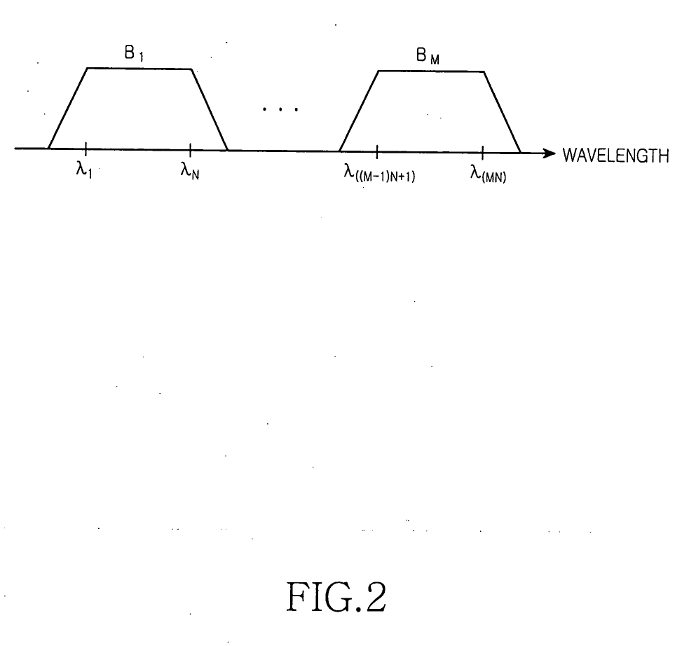

FIG. 2 is a view showing the first, second, third, . . . , M^{th} band light which are emitted from the first, second, third, . . . , M^{th} band light sources shown in FIG. 1.

Referring to FIGS. 1 and 2, the first, second, third, . . . , M^{th} broadband light sources 110-1, 110-2, 110-3, . . . , 110-M are connected to the M-CWDM 120 and output the first, second, third, . . . , M^{th} band light. The J^{th} broadband light source 110-j outputs a j^{th} band light Bⱼ which has wavelengths ((j-1)N+1)^{th} through (jN)^{th}, represented as λ_{(j-1)N+1)}˜λ_{(jN)}, wherein the index j is a positive integer less than or equal to M. The first, second, third, . . . , M^{th} light bands are arranged at a desired interval. For example, the wavelength interval between the first wavelength π₁ and the (N+1)^{th} wavelength λ_{(N+1)} has a length identical to that of the wavelength interval between the (N+1)^{th} wavelength λ_{(N+1)} and the (2N+I) th wavelength λ_{(2N+1)}. The first, second, third, . . . , M^{th} broadband light sources 110-1, 110-2, 110-3, . . . , 110-M may include an erbium doped optical fiber amplifier (EDFA) which outputs amplified spontaneous light (ASE).

The M-CWDM 120 is provided with first, second, third, . . . , M^{th} demultiplexing ports (DP) and a multiplexing port (MP). The first, second, third, . . . , M^{th} demultiplexing ports are connected point to point to the first, second, third, . . . , M^{th} broadband light sources 110-1, 110-2, 110-3, . . . , 110-M. The multiplexing port is connected to the optical circulator 130. The M-CWDM 120 multiplexes, for output through the multiplexing port, the first, second, third, . . . , M^{th} light bands inputted into the first, second, third, . . . , M^{th} demultiplexing ports. A 1×M arrayed waveguide grating (AWG) may be used as the M-CWDM 120 and the first, second, third, . . . , N^{th} S-CWDM 150-1, 150-2, 150-3, . . . , 150-N.

The optical circulator 130 includes first, second, and third ports. The first port is connected to the multiplexing port of the M-CWDM 120. The second port is connected to the DWDM 140. The third port is connected to an external device or optical fibers. The optical circulator 130 outputs the multiplexed light inputted into the first port to the second port, while outputting multiplexed optical signals inputted into the second port to the third port.

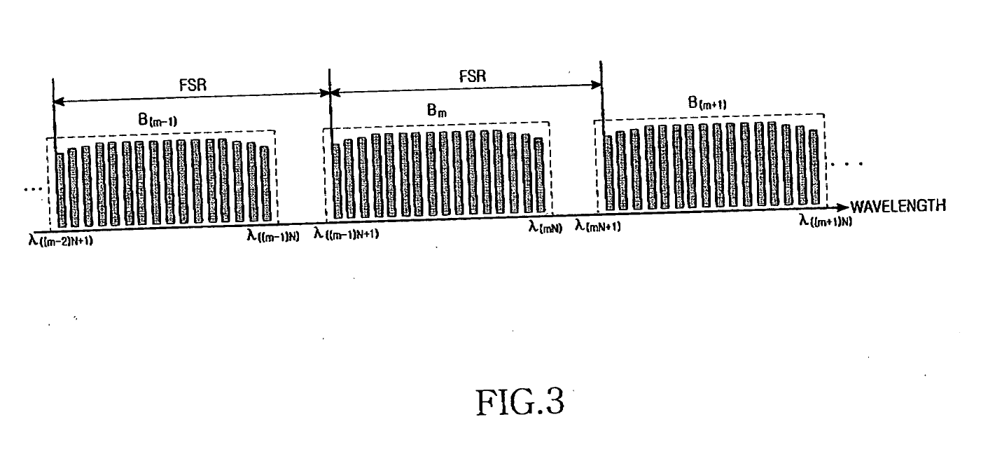

FIG. 3 is a transmission spectrum of the dense wavelength division multiplexer 140 shown in FIG. 1 for portraying spectrum division characteristic of the dense wavelength division multiplexer 140. Demultiplexing refers to the simple division of the inputted multiplexed light into each wavelength. The expression “spectrum division” indicates that a certain band of the inputted light is filtered and that desired channels are extracted from the filtered light.

Referring to FIGS. 1 and 3, the DWDM 140 is provided with a multiplexing port and first, second, third, . . . , N^{th} demultiplexing ports. The multiplexing port is connected to the second port of the optical circulator 130. The first, second, third, . . . , and N^{th} demultiplexing ports are connected point to point, and in order, to the first, second, third, . . . , N^{th} S-CWDM 150-1, 150-2, 150-3, . . . , and 150-N, respectively. The DWDM 140 spectrally divides the multiplexed light inputted into the multiplexing port into channels corresponding to structural wavelengths of the light, and then outputs the channels to the first, second, third, . . . , N^{th} demultiplexing ports. The DWDM 140 also multiplexes the first, second, third, . . . , N^{th} groups of the optical signals which are inputted into the first, second, third, . . . , N^{th} demultiplexing ports for output to the multiplexing port as multiplexed optical signals. The DWDM 140 outputs the first, second, third, . . . , M^{th} channels in the k^{th} group to the k^{th} demultiplexing port. The M^{th} channel of the k^{th} group has the ((m-1)N+k)^{th} wavelength λ_{(m-1)N+k}, in which the index k is a positive integer less than or equal to N. As shown in FIG. 3, a free spectral range (FSR) of the DWDM 140 is set to be identical with wavelength period in the first, second, third, . . . , M^{th} band, and transmission wavelengths of the DWDM 140 are identical with the structural wavelengths of the light bands.

The p^{th} S-CWDM 150-p is provided with a multiplexing port and first, second, third, . . . , M^{th} demultiplexing ports. The multiplexing port is connected to the p^{th} demultiplexing port of the DWDM 140, while the first, second, third, . . . , M^{th} demultiplexing ports are connected point to point, and in order, to first, second, third, . . . , M^{th} light injected light source 160-n-1, 160-n-2, 160-n-3, . . . , 160-n-M, respectively. The p^{th} S-CWDM 150-p demultiplexes the first, second, third, . . . , M^{th} channels of the p^{th} group inputted into the multiplexing port for respective output as demultiplexed channels to the first, second, third, . . . , M^{th} demultiplexing ports. The p^{th} S-CWDM 150-p likewise multiplexes the first, second, third, . . . , M^{th} optical signals of the p^{th} group sequentially inputted into the first, second, third, . . . , M^{th} demultiplexing ports respectively for output over the multiplexing port.

The m^{th} light injected light source 160-n-m of the n^{th} group 160-n outputs the m^{th} optical signals of the n^{th} group to the m^{th} demultiplexing port of the n^{th} S-CWDM 150-n. The m^{th} optical signals are generated from the m^{th} channel of the n^{th} group injected from the m^{th} demultiplexing port of the n^{th} S-CWDM 150-n, in which data are modulated. The m^{th} channel of the n^{th} group has the same wavelength as that of the m^{th} optical signal of the n^{th} group. A Fabry-Perot laser or a reflective semiconductor optical amplifier may be used as the light injected light sources 160-1-1, 160-1-2, 160-1-2, . . . , 160-N-M of the first, second, third, . . . , N^{th} groups 160-1, 160-2, 160-3, . . . , 160-N.

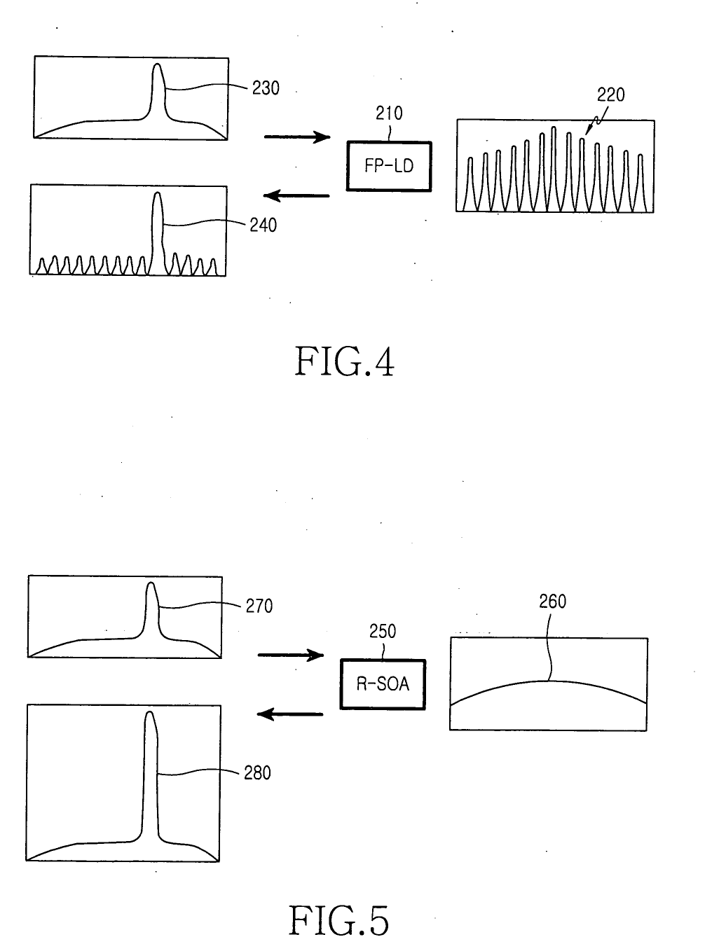

FIG. 4 illustrates one example of an input/output characteristic of an external light injection type Fabry-Perot laser diode. The Fabry-Perot laser 210 is provided with a plurality of oscillating modes 220. The laser 210 receives injected light 230 that has been inputted to an input/output terminal. The laser 210 generates optical signals 240 according to the oscillating modes 220, and outputs to the input/output terminal the resulting optical signals 240 in which data is modulated, whose wavelengths are identical to the wavelengths of the injected light 230.

FIG. 5 illustrates an example of an input/output characteristic of an external light injection type reflective semiconductor optical amplifier. The reflective semiconductor optical amplifier 250 has a broad gain band 260. The amplifier 250 amplifies the injected light 270 inputted into the input/output terminal. The amplification generates for output to the input/output terminal the optical signals 280 in which data is modulated.

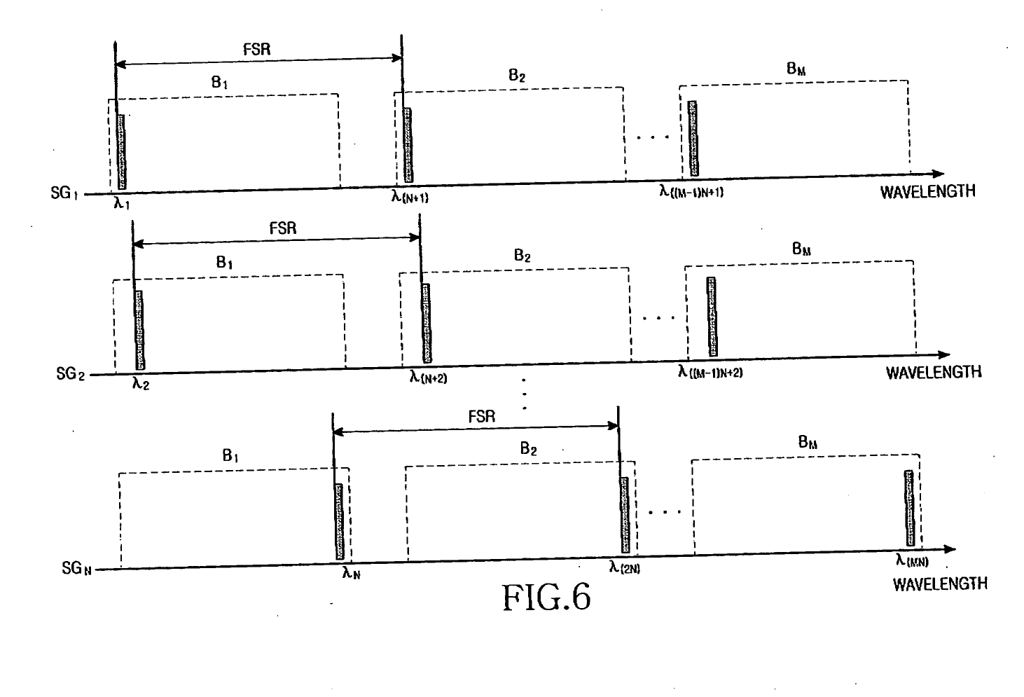

FIG. 6 shows an exemplary depiction of the optical signals of the first, second, third, . . . , N^{th} groups which propagate into the wavelength division multiplexed light source 100 of FIG. 1. As shown in FIG. 6, the first, second, third, . . . , M^{th} optical signals of the first group SG₁, have the wavelengths of λ₁, λ_{(N+1)}, . . . , λ_{(M-1)N+1)}, respectively. The first, second, third, . . . , M^{th} optical signals of the second group SG₂ have the wavelengths of λ₂, λ_{(N+2)}, . . . , λ_{(M-1)N+2)}, respectively. The first, second, third, . . . , M^{th} optical signals of the N^{th} group SG_{N} has the wavelengths of λ_{N}, λ_{(2N)}, . . . , λ_{(MN)}, respectively.

The wavelength division multiplexed light sources as described above can be applied to a voluntary passive optical network. The discussion that follows pertains to a downstream transmission of the passive optical network according to the first embodiment of the present invention. Subsequent description relates to upstream and downstream transmissions of the passive optical network according to the second embodiment.

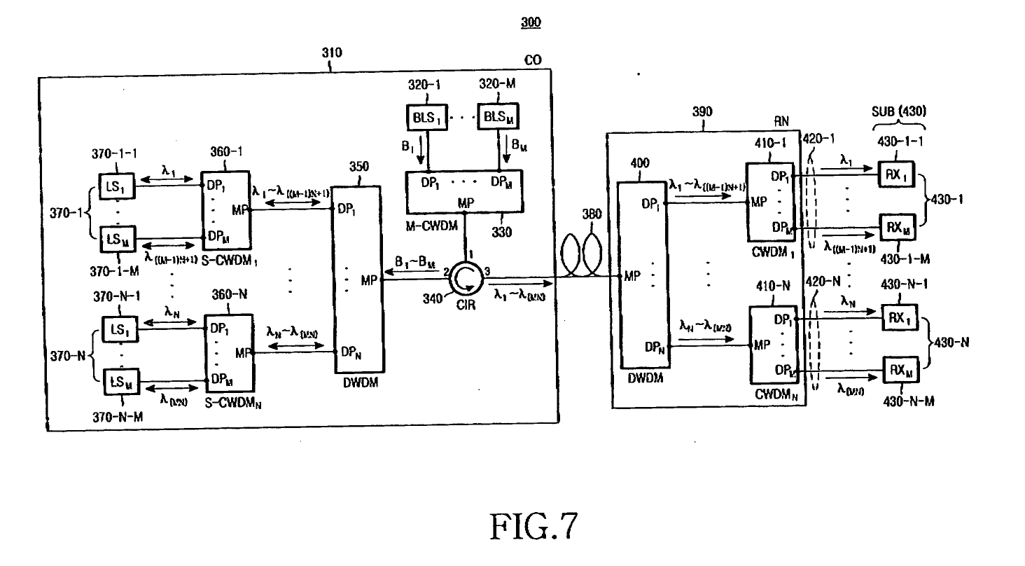

FIG. 7 provides, by way of illustrative and non-limitative example, a passive optical network using a wavelength division multiplexing scheme according to the first embodiment of the present invention. The passive optical network 300 includes a central office 310, remote node 390 connected to the central office 310 through trunk optical fibers 380, and subscriber side apparatus 430 connected to the remote node 390 through distributed optical fibers of the first, second, third, . . . , N^{th} groups 420-1, 420-2, 420-3, . . . , 420-N.

The central office 310 includes the first, second, third, . . . , M^{th} broadband light sources 320-1, 320-2, 320-3, . . . , 320-M; a main coarse wavelength division multiplexer (M-CWDM) 330; an optical circulator (CIR) 340; a dense wavelength division multiplexer (DWDM) 350; the first, second, third, . . . , N^{th} secondary coarse wavelength division multiplexer (S-CWDM) 360-1, 360-2, 360-3, 360-N; and external light injection type light sources 370-1-1, 370-1-2, 370-1-3, . . . , 370-N-M of the first, second, third, . . . , N^{th} groups 370-1, 370-2, 370-3, . . . , 370-N.

The first, second, third, . . . , M^{th} broadband light sources 320-1, 320-2, 320-3, 320-M are connected to the M-CWDM 330, which outputs the light of the first, second, third, . . . , M^{th} bands B1, B2, B3, . . . , B_{M}. The m^{th} broadband light source 320-m outputs the light of the m^{th} band Bₘ which includes the ((m-1)N+1)^{th} to the (mN)^{th} wavelengths λ_{(m-1)N+1} to λ_{(mN)}. The first, second, third, . . . , M^{th} bands are arranged in periodic wavelength intervals.

The M-CWDM 330 is provided with the first, second, third, . . . , M^{th} demultiplexing ports DP and the multiplexing port MP. The first, second, third, . . . M^{th} demultiplexing ports are sequentially connected point to point to the first, second, third, . . . , M^{th} broadband light sources 320-1, 320-2, 320-3, . . . , 320-M. The multiplexing port MP is connected to the optical circulator 340. The M-CWDM 330 multiplexes the first, second, third, . . . , M^{th} band light inputted into the first, second, third, . . . , M^{th} demultiplexing ports and then outputs the multiplexed light to the multiplexing port MP.

The optical circulator 340 is provided with the first, second and third ports. The first port is connected to the multiplexing port MP of the M-CWDM 330. The second port is connected to the DWDM 350. The third port is connected to the trunk optical fiber 380. The optical circulator 340 outputs to the second port the multiplexed light inputted into the first port and also outputs the multiplexed optical signals, which are inputted into the second port, to the third port.

The DWDM 350 is provided with the multiplexing port MP and the first, second, third, . . . , N^{th} demultiplexing ports. The multiplexing port MP is connected to the second port of the optical circulator 340. The first, second, third, . . . , N^{th} demultiplexing ports are sequentially connected point to point to the first, second, third, . . . , N^{th} S-CWDM 360-1, 360-2, 360-3, . . . , 360-N. The DWDM 350 spectrally divides the multiplexed light inputted into the multiplexed port into the channels corresponding to the structural wavelengths of the multiplexed light and then outputs the channels to the first, second, third, . . . , N^{th} demultiplexed ports. The DWDM 350 likewise multiplexes the optical signals of the first, second, third, . . . , N^{th} groups inputted into the first, second, third, . . . , N^{th} demultiplexing ports and then outputs the multiplexed optical signals to the multiplexing port MP. In particular, the DWDM 350 outputs the first, second, third, . . . , M^{th} channels of the n^{th} group to the n^{th} demultiplexing port. The m^{th} channel of the r^{th} group has an ((m-1)N+r)^{th} wavelength, r being a positive integer less than or equal to N. The free spectral range of the DWDM 350 is set to be identical with the wavelength period of the first, second, third, . . . , M^{th} bands.

The n^{th} S-CWDM 360-n is provided with first, second, third, . . . , M^{th} demultiplexing ports. The multiplexing port is connected to the n^{th} demultiplexing port of the DWDM 350, while the first, second, third, . . . , M^{th} demultiplexing ports are sequentially connected point to point to the first, second, third, . . . , M^{th} external light injection type light sources 370-N-1, 370-N-2, 370-N-3, . . . , 370-N-M. The n^{th} S-CWDM 360-n demultiplexes the first, second, third, . . . , M^{th} channels of the n^{th} group inputted into its multiplexing port and then sequentially outputs the demultiplexed channels to its first, second, third, . . . , M^{th} demultiplexing ports one by one. The n^{th} S-CWDM 360-n likewise multiplexes the first, second, third, . . . , M^{th} optical signals of the n^{th} group sequentially inputted into the first, second, third, . . . , M^{th} demultiplexing ports one by one, and then outputs the multiplexed optical signals to its multiplexing port.

The m^{th} external light injection light source 370-n-M of the n^{th} group 370-n outputs the m^{th} optical signal of the n^{th} group which is generated by the m^{th} channel of the n^{th} group. The m^{th} optical signal, in which data are modulated, is inputted from the m^{th} demultiplexing port of the n^{th} S-CWDM 360-n. The m^{th} channel of the n^{th} group has the same wavelength as that of the m^{th} optical signal of the n^{th} group.

The remote node 390 includes a DWDM 400 and first, second, third, . . . , N^{th} CWDMs 410-1, 410-2, 410-3, . . . , 410-N.

The DWDM 400 is provided with a multiplexing port and first, second, third, . . . , N^{th} demultiplexing ports. The multiplexing port is connected to the trunk optical fiber 380. The first, second, third, . . . , N^{th} demultiplexing ports are sequentially connected point to point to the first, second, third, . . . , N^{th} CWDMs 410-1, 410-2, 410-3, . . . , 410-N. The DWDM 400 demultiplexes the multiplexed optical signals inputted into the multiplexing port to its structural optical signals and then outputs the demultiplexed optical signal to the first, second, third, . . . , N^{th} demultiplexing ports. The DWDM 400 outputs the first, second, third, . . . , M^{th} optical signals of the N^{th} group to the n^{th} demultiplexing port. The DWDM 400 has the same free spectral range as that of the DWDM 350 of the central office.

The n^{th} CWDM 410-n is provided with a multiplexing port and first, second, third, . . . , and M^{th} demultiplexing ports. The multiplexing port is connected to the n^{th} demultiplexing port of the DWDM 400, while the first, second, third, . . . , M^{th} demultiplexing ports are sequentially connected point to point to the distributed optical fibers. The n^{th} CWDM 360-n demultiplexes the first, second, third, . . . , M^{th} channels of the n^{th} group inputted into the multiplexing port and then respectively outputs the demultiplexed channels to the first, second, third, . . . , M^{th} demultiplexing ports.

The subscriber side apparatus 430 includes optical receivers 430-1-1, 430-1-2, 430-1-3, . . . , 430-N-M of first, second, third, . . . , N^{th} groups 430-1, 430-2, 430-3, . . . , 430-N. The first, second, third, . . . , M^{th} optical receivers of the n^{th} group 430-n are sequentially connected point to point to the distributed optical fibers.

The m^{th} optical receiver 430-n-m of the n^{th} group 430-n is connected to the m^{th} demultiplexing port of the n^{th} CWDM 410-n through the corresponding distributed optical fiber of the n^{th} group 420-n. The optical receiver 430-n-m receives the m^{th} optical signal of the n^{th} group and detects the optical signal by means of an electric signal.

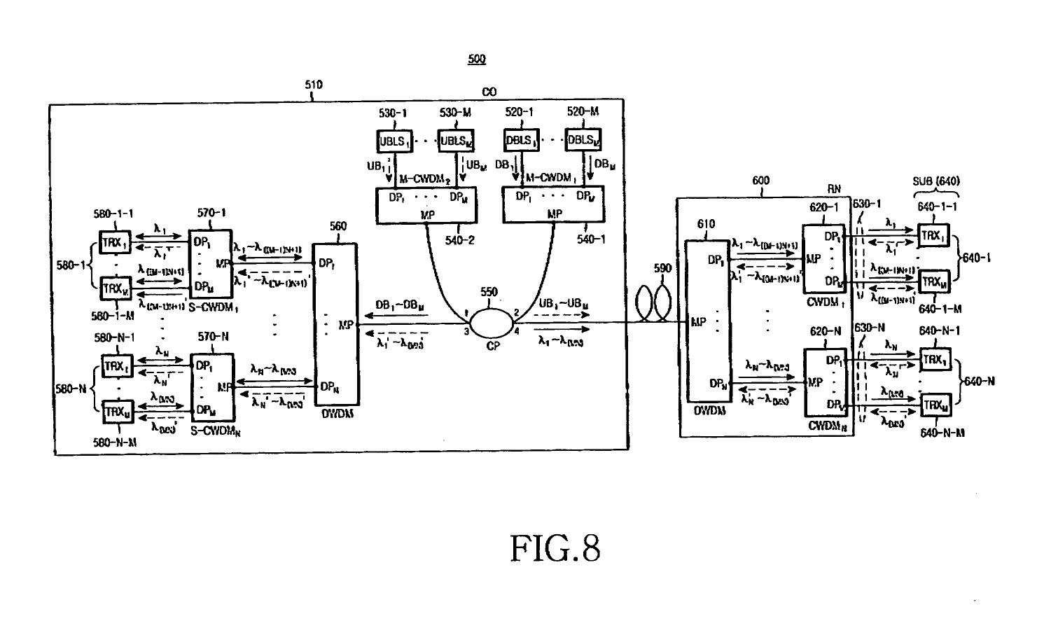

FIG. 8 shows, by way of example, a passive optical network using a wavelength division multiplexed scheme according to the second embodiment of the present invention. The passive optical network 500 includes a central office 510; a remote node 600 connected to the central office 510 through a trunk optical fiber 590; and a subscriber side apparatus 640 connected to the remote node 600 through distributed optical fibers 630-1, 630-2, 630-3, . . . , 630-N of the first, second, third, . . . , and N^{th} groups. In FIG. 8, a broken line is used to depict light, channel, and optical signal of an upstream wavelength band, and a solid line depicts light, channel and optical signal of a downstream wavelength band.

The central office 510 includes first, second, third, . . . , M^{th} downstream broadband light sources 520-1, 520-2, 520-3, . . . , 520-M; first, second, third, . . . , M^{th} upstream broadband light sources 530-1, 530-2, 530-3, . . . , 530-M; first and second main coarse wavelength division multiplexers 540-1, 540-2; an optical coupler 550; a dense wavelength division multiplexer 560; first, second, third, . . . , N^{th} secondary coarse wavelength division multiplexers 570-1, 570-2, 570-3, . . . , 570-N; and external light injection type light sources 580-1-1, 580-1-2, 580-1-3, . . . , 580-N-M of first, second, third, . . . , N^{th} groups 580-1, 580-2, 580-3, . . . , 580-N.

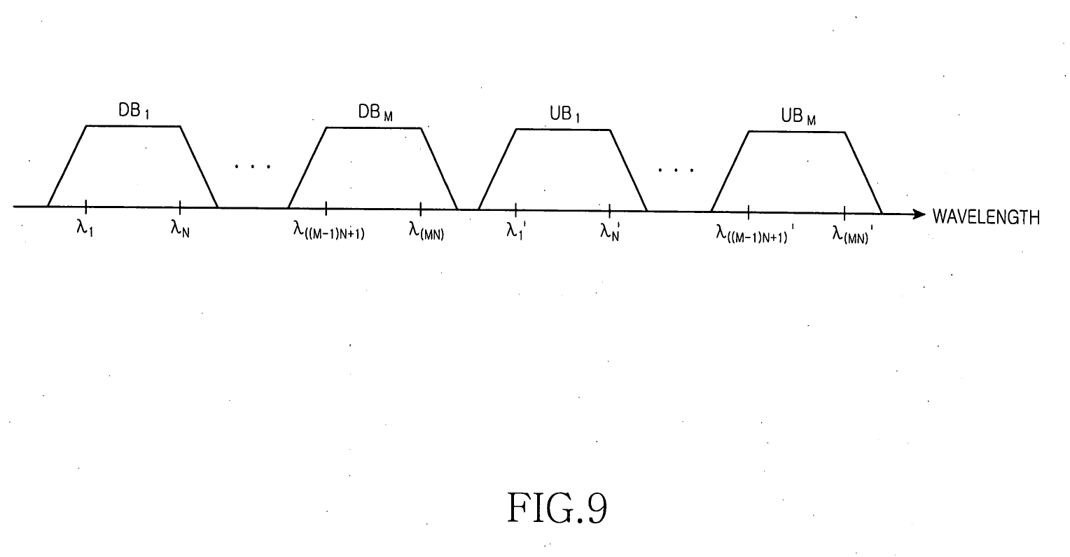

FIG. 9 is a view showing the first, second, third, . . . , and M^{th} downstream bands and the first′, second′, third′, . . . , and M^{th} upstream bands.

Referring to FIGS. 8 and 9, the first, second, third, . . . , and M^{th} downstream broadband light sources 520-1, 520-2, 520-3, . . . , 530-M are connected to the first M-CWDM 540-1, which outputs light of the first, second, third, . . . , M^{th} , downstream bands DB₁, DB₂, DB₃, . . . , DB_{M}. The light source of the m^{th} downstream broadband 520-m outputs the light of the m^{th} downstream band DBₘ. The m^{th} downstream band includes ((m-1)N+1)^{th} through (mN)^{th} wavelengths λ_{(m-1)N+1} to λ_{(mN)}. The first, second, third, . . . , M^{th} downstream bands are periodically arranged on the axis of the wavelength, i.e., arranged such that the distances between the start of one band and the start of the next band are uniform along the axis.

The first M-CWDM 540-1 is provided with the first, second, third, . . . , M^{th} demultiplexing ports DP and a multiplexing port MP. The first, second, third, . . . , M^{th} demultiplexing ports are sequentially connected point to point to the first, second, third, . . . , M^{th} downstream broadband light sources 520-1, 520-2, 520-e, . . . , 520-M. The multiplexing port is connected to the optical coupler 550. The first M-CWDM 540-1 multiplexes the light of the first, second, third, . . . , M^{th} downstream band inputted into the first, second, third, . . . , M^{th} demultiplexing ports, and then outputs the multiplexed light to the multiplexing port.

The first, second, third, . . . , M^{th} upstream broadband light sources 530-1, 530-2, 530-3, . . . , 530-M are connected to the second M-CWDM 540-2, which outputs the light of the first, second, third, . . . , M^{th} upstream bands UB1, UB2, UB3, . . . , UBM. The m^{th} upstream broadband light source 530-m outputs the light of the m^{th} upstream band UBM, while the m^{th} upstream band includes ((m-1)N+1)^{th}′ through (mN)^{th}′ wavelength λ_{(m-1)N+1)}′ to λ_{(mN)}′ as its structural wavelength. The first, second, third, . . . , M^{th} upstream bands are periodically arranged on an axis of the wavelength, i.e., arranged such that the distances between the start of one band and the start of the next band are uniform along the axis.

The second M-CWDM 540-2 is provided with the first, second, third, . . . , M^{th} demultiplexing ports DP and a multiplexing port MP. The first, second, third, . . . . , M^{th} demultiplexing ports are sequentially connected point to point to the first, second, third, . . . , M^{th} upstream broadband light source 530-1, 530-2, 530-3, . . . , 530-M. The multiplexing port is connected to the optical coupler 550. The second M-CWDM 540-2 multiplexes the light of the first, second, third, . . . , M^{th} upstream bands inputted into the first, second, third, . . . , M^{th} demultiplexing ports and then outputs the multiplexed light to the multiplexing port.

The optical coupler 550 is provided with the first, second, third and fourth ports. The first port is connected to the multiplexing port of the second M-CWDM 540-2. The second port is connected to the multiplexing port of the first M-CWDM 540-1. The third port is connected to the DWDM 560. The fourth port is connected to the trunk optical fiber 590. The optical coupler 550 outputs the multiplexed light inputted into the first port to the fourth port, and then outputs the multiplexed light inputted into the second port to the third port. The optical coupler 550 also outputs the multiplexed downstream optical signal inputted into the third port to the fourth port, and then outputs the multiplexed upstream optical signal inputted into the fourth port to the third port.

The DWDM 560 is provided with a multiplexing port and first, second, third, . . . , N^{th} demultiplexing ports. The multiplexing port is connected to the third port of the optical coupler 550. The first, second, third, . . . , N^{th} demultiplexing ports are sequentially connected point to point to the first, second, third, . . . , N^{th} S-CWDMs 570-1, 570-2, 570-3, . . . , 570-N. The DWDM 560 spectrally divides the multiplexed light, which is inputted into the multiplexing port, into downstream channels corresponding to its structural wavelength and then outputs the downstream channels to the first, second, third, . . . , N^{th} demultiplexing ports. The DWDM 560 multiplexes the downstream optical signals of the first, second, third, . . . , N^{th} groups inputted into the first, second, third, . . . , N^{th} demultiplexing ports and then outputs the multiplexed downstream optical signals to the multiplexing port. The DWDM 560 outputs the first, second, third, . . . , M^{th} downstream channels of the n^{th} group to the n^{th} demultiplexing port. The m^{th} downstream channel of the n^{th} group has an ((m-1)N+n)^{th} wavelength. Moreover, the DWDM 560 demultiplexes the multiplexed upstream optical signal inputted into the multiplexing port and then outputs the demultiplexed upstream optical signal to the first, second, third, . . . , N^{th} demultiplexing port. The DWDM 560 outputs the first, second, third, . . . , M^{th} upstream optical signal of the n^{th} group to the n^{th} demultiplexing port. The m^{th} upstream optical signal of the n^{th} group has an ((m-1)N+n)^{th} wavelength. The free spectral range of the DWDM 560 is set to be identical with wavelength period of the first, second, third, . . . , M^{th} downstream band. Also, wavelength period of the first, second, third, . . . , M^{th} upstream band is identical with the free spectral range.

The n^{th} S-CWDM 570-n is provided with a multiplexing port and first, second, third, . . . , M^{th} demultiplexing ports. The multiplexing port is connected to the n^{th} demultiplexing port of the DWDM 560, while the first, second, third, . . . , M^{th} demultiplexing ports are sequentially connected point to point to first, second, third, . . . , M^{th} external light injection type light source 580-N-1, 580-N-2, 580-N-3, . . . , 580-N-M of the n^{th} group 580-n. The n^{th} S-CWDM 570-n demultiplexes first, second, third, . . . , M^{th} downstream channels of the n^{th} group which is inputted into the multiplexing port and then sequentially outputs, respectively, the demultiplexed channels to the first, second, third, . . . , M^{th} demultiplexing port. The n^{th} S-CWDM 570-n also respectively multiplexes first, second, third, . . . , M^{th} downstream optical signals of the n^{th} group sequentially inputted into the first, second, third, . . . , M^{th} demultiplexing ports, and then outputs the multiplexed downstream optical signals to the multiplexing port. Moreover, the n^{th} S-CWDM 570-n demultiplexes the first, second, third, . . . , M^{th} upstream optical signals of the n^{th} group which are inputted into the multiplexing port, and then sequentially outputs, respectively, the demultiplexed upstream optical signals to the first, second, third, . . . , M^{th} demultiplexing port.

An m^{th} light transceiver 580-n-m of the n^{th} group 580-n outputs an m^{th} downstream optical signal of an n^{th} group, which is generated by an m^{th} downstream channel of the n^{th} group injected from the m^{th} demultiplexing port of the n^{th} S-CWDM 570-n and in which data are modulated, to an m^{th} demultiplexing port of the n^{th} S-CWDM 570-n. The m^{th} downstream channel of the n^{th} group has the same wavelength as the m^{th} downstream optical signal of the n^{th} group. Furthermore, the m^{th} light transceiver 580-n-m of the n^{th} group 580-n detects, by electric signal, the m h upstream optical signal of the n^{th} group inputted from the m^{th} demultiplexing port of the n^{th} S-CWDM 570-n.

The remote node 600 includes the DWDM 610 and first, second, third, . . . , N^{th} CWDMs 620-1, 620-2, 620-3,..., 620-N.

The DWDM 610 is provided with a multiplexing port and first, second, third, . . . , N^{th} demultiplexing ports. The multiplexing port is connected to the trunk optical fiber 590. The first, second, third, . . . , and N^{th} demultiplexing ports are sequentially connected point to point to the first, second, third, . . . , and N^{th} CWDM 620-1, 620-2, 620-3, . . . , and 620-N. The DWDM 610 spectrally divides the multiplexed light, which is inputted into the multiplexing port, into upstream channels corresponding to a structural wavelength of the light, and then outputs the upstream channels to the first, second, third, . . . , N^{th} demultiplexing port. The DWDM 610 also multiplexes upstream optical signals of the first, second, third, . . . , N^{th} group inputted into the first, second, third, . . . , N^{th} demultiplexing ports, and then outputs the multiplexed upstream optical signals to the multiplexing port. The DWDM 610 outputs the first, second, third, . . . , M^{th} upstream channels of the n^{th} group to an n^{th} demultiplexing port. Moreover, the DWDM 610 demultiplexes the multiplexed downstream optical signals inputted into the multiplexing port, and then outputs the demultiplexed downstream optical signals to the first, second, third, . . . , N^{th} demultiplexing port. The DWDM 610 outputs the first, second, third, . . . , M^{th} downstream optical signal of the n^{th} group to the n^{th} demultiplexing port. The DWDM 610 has the same free spectral range as that the DWDM 560 of the central office.

The n^{th} CWDM 620-n is provided with a multiplexing port and first, second, third, . . . , M^{th} demultiplexing ports. The multiplexing port is connected to the n^{th} demultiplexing port of the DWDM 610, while the first, second, third, . . . , and M^{th} demultiplexing ports are sequentially connected point to point to the distributed optical fiber of the n^{th} group 630-n. The n^{th} CWDM 620-n demultiplexes first, second, third, . . . , M^{th} channels of the n^{th} group which are inputted into the multiplexing port, and outputs the demultiplexed channels to the first, second, third, . . . , M^{th} demultiplexing ports one by one. The n^{th} CWDM 620-n also respectively multiplexes first, second, third, . . . , M^{th} upstream optical signals of the n^{th} group inputted into the first, second, third, . . . , M^{th} demultiplexing ports, and then outputs the multiplexed upstream optical signal to the multiplexing port. Moreover, the n^{th} CWDM 620-n demultiplexes first, second, third, . . . , M^{th} downstream optical signals of the n^{th} group inputted into the multiplexing port, and then respectively outputs the demultiplexed downstream optical signals to the first, second, third, . . . , M^{th} demultiplexing ports.

The subscriber side apparatus 640 includes a light transceiver 640-1-1, 640-1-2, 640-1-3, . . . , 640-N-M of first, second, third, . . . , and N^{th} groups 640-1, 640-2, 640-3, . . . , 640-N. The first, second, third, . . . , and M^{th} light transceivers 640-n-1, 640-n-2, 640-n-3, . . . , 640-n-M of the n^{th} group 640-n are connected point to point to distributed optical fibers.

The m^{th} transceiver 640-n-m of the n^{th} group 640-n is connected to the m^{th} demultiplexing port of the n^{th} CWEM 630-n through the corresponding distributed optical fiber of the n^{th} group 640-n. The m^{th} transceiver CWDM 640-n-m of the n^{th} group 640-n outputs the m^{th} upstream optical signal of the n^{th} group, which is generated by the m^{th} upstream channel of the n^{th} group injected from the m^{th} demultiplexing port of the n^{th} CWDM 630-n and in which data are modulated, to the m^{th} demultiplexing port of the n^{th} CWDM 630-n. The m^{th} upstream channel of the n^{th} group has the same wavelength as that of the m^{th} upstream optical signal of the n^{th} group. Moreover, the m^{th} transceiver 640-n-m of the n^{th} group 640-n detects, using an electric signal, the m^{th} downstream optical signal of the n^{th} group inputted from the m^{th} demultiplexing port of the n^{th} S-CWDM 630-n.

As described above, the wavelength division multiplexed light source and the passive optical network using the same according to the present invention use the coarse wavelength division multiplexers and the free spectral range of the dense wavelength division multiplexer so as to perform the spectrum division, demultiplexing, and multiplexing. This affords economical accommodation of a great number of subscribers in comparison with the conventional optical network.

While the invention has been shown and described with reference to the preferred embodiments thereof, it will be understood by those skilled in the art that various changes in form and details may be made therein without departing from the spirit and scope of the invention as defined by the appended claims.

What is claimed is:

1. A wavelength division multiplexed light source comprising:
a plurality of broadband light sources producing respective light bands, the light bands having respective pluralities of structural wavelengths, the structural wavelengths having corresponding channels, the plural sources being arranged such that a wavelength period between a start of a current band and a start of a next band is uniform along a wavelength axis;
a main coarse wavelength division multiplexer (M-CWDM) which multiplexes a plurality of lights inputted from the broadband light sources so as to output a multiplexed light; and
a dense wavelength division multiplexer (DWDM) which spectrally divides the multiplexed light inputted from the M-CWDM into said channels, so as to generate multiple different groups whose channels are spaced apart by said wavelength period.

2. The wavelength division multiplexed light source as claimed in claim 1, further comprising a plurality of secondary coarse wavelength division multiplexers (S-CWDM) which are connected to the DWDM so as to demultiplex the channels of the corresponding group inputted from the DWDM.

3. The wavelength division multiplexed light source as claimed in claim 2, further comprising external light injection type light sources connected to corresponding ones of the plural S-CWDMs so as to output optical signals in which data are modulated, said signals being generated by corresponding injected channels.

4. The wavelength division multiplexed light source as claimed in claim 3, further comprising an optical circulator which is disposed between the M-CWDM and the DWDM so as to output the multiplexed light inputted from the M-CWDM to the DWDM and so as to output the multiplexed optical signals inputted from the DWDM out of the wavelength division multiplexed light source, wherein the optical signals outputted from the external light injection type light sources are multiplexed by said plural S-CWDMs and the DWDM.

5. The wavelength division multiplexed light source as claimed in claim 1, wherein said wavelength period is a free spectral range of the DWDM.

6. A wavelength division multiplexed light source comprising:
a dense wavelength division multiplexer (DWDM) which spectrally divides lights having different wavelength bands, said bands being periodically disposed on a wavelength axis such that a wavelength period between a start of a current band and a start of a next band is uniform along said axis, said current band having a plurality of structural wavelengths, the spectral division being into channels corresponding to the structural wavelengths of the lights so as to generate multiple different groups whose ones of said channels are spaced apart by said wavelength period;
a plurality of secondary coarse wavelength division multiplexers (S-CWDMs) which are connected to the DWDM and demultiplex said channels; and
external light injection type light sources connected to corresponding ones of the plural S-CWDMs, so as to output optical signals in which data are modulated, said signals being generated by corresponding ones of said channels.

7. The wavelength division multiplexed light source as claimed in claim 6, wherein the wavelength period is a free spectral range of the DWDM.

8. A passive optical network comprising:
a central office outputting multiplexed optical signals, which includes:
a dense wavelength division multiplexer (DWDM) which spectrally divides lights having different wavelength bands, said bands being periodically disposed on a wavelength axis such that a wavelength period between a start of a current band and a start of a next band is uniform along said axis, said current band having a plurality of structural wavelengths, the spectral division being into channels corresponding to the structural wavelengths of the lights so as to generate multiple different groups whose ones of said channels are spaced apart by said wavelength period;
a plurality of secondary coarse wavelength division multiplexers (S-CWDMs) which are connected to the DWDM and demultiplex said channels; and
external light injection type light sources connected to corresponding ones of the plural S-CWDMs, so as to output optical signals in which data are modulated, said signals being generated by corresponding ones of said channels;
a remote node demultiplexing multiplexed optical signals that are inputted from the central office through a trunk optical fiber, and outputting the demultiplexed optical signals; and
a subscriber side apparatus detecting, by electric signals, the demultiplexed optical signals, which are inputted from the remote node through distributed optical fibers of multiple ones of said groups.

9. The network of claim 8, wherein said multiplexed optical signals inputted from the central office are received from a circulator joining said DWDM to a main coarse wavelength division multiplexer (M-CWDM).

10. The passive optical network as claimed in claim 8, wherein the central office further comprises:
a plurality of broadband light sources outputting lights of wavelength bands having corresponding structural wavelengths; and
a main coarse wavelength division multiplexer multiplexing lights inputted from the broadband light sources for output to the DWDM.

11. The passive optical network as claimed in claim 8, wherein the wavelength period is a free spectral range of the DWDM.

12. A passive optical network comprising:
a central office outputting multiplexed optical signals;
a remote node demultiplexing the multiplexed optical signals inputted from the central office through a trunk optical fiber, which includes:
a dense wavelength division multiplexer (DWDM) demultiplexing the multiplexed optical signals inputted from the central office into their structural optical signals, so as to output optical signals of a plurality of different groups whose respective ones of the outputted optical signals are spaced at the free spectral range; and
a plurality of secondary coarse wavelength division multiplexers (S-CWDMs) that are connected to the DWDM and demultiplex the optical signals of the corresponding group inputted from the DWDM so as to output demultiplexed optical signals;
a subscriber side apparatus detecting, by electric signals, demultiplexed optical signals inputted from the remote node through distributed optical fibers of the plural groups.

13. A passive optical network comprising:
a central office multiplexing lights of different wavelength bands which are periodically arranged on a wavelength axis and respectively have a plurality of structural wavelengths, so as to output the multiplexed lights;
a remote node spectrally dividing the multiplexed lights, which are inputted from the central office through a trunk optical fiber, into channels corresponding to structural wavelengths of the light, so as to output the channels of multiple different groups having corresponding pluralities of channels spaced at a wavelength period common between consecutive pairs of the channels; and
a subscriber side apparatus including external light injection type light sources of respective ones of the groups, said sources outputting optical signals of the corresponding group, data being modulated in said optical signals, said signals being generated by channels of the corresponding group injected from the remote node.
